(19) United States
(12) Patent Application Publication
(10) Pub. No.: US 2025/0162667 A1
(43) Pub. Date: May 22, 2025

(54) METHOD OF MANUFACTURING OFF-ROAD VEHICLE AND OFF-ROAD VEHICLE

(71) Applicant: KAWASAKI MOTORS, LTD., Hyogo (JP)

(72) Inventors: Kouji ITOU, Akashi-shi (JP); Teruaki YAMAMOTO, Akashi-shi (JP)

(73) Assignee: KAWASAKI MOTORS, LTD., Hyogo (JP)

(21) Appl. No.: 18/517,590

(22) Filed: Nov. 22, 2023

(51) Int. Cl. B62D 65/14; B60N 2/005; B62D 21/03; B62D 25/08; B62D 65/04

(52) U.S. Cl. CPC B62D 65/14; B60N 2/005; B62D 21/03; B62D 25/08; B62D 65/04

(57) ABSTRACT

A method of manufacturing a utility vehicle 100 includes: preparing a ladder frame 3; attaching a vehicle front part 4 that includes a front panel 12 defining a front end of a compartment and is mounted on top of the ladder frame 3 to the ladder frame 3; attaching a vehicle rear part 5 that includes a rear panel 13 defining a rear end of the compartment and is mounted on top of the ladder frame 3 to the ladder frame 3; and attaching one or a plurality of seat row modules 6, each of which includes a seat frame 62 supporting a seat row 61 having seats 63 arranged side by side in a lateral direction of the vehicle and is mounted on top of the ladder frame 3 to the ladder frame 3 between the vehicle front part 4 and the vehicle rear part 5. The number of the one or plurality of seat row modules 6 corresponds to the number of the seat rows 61 included in a vehicle body 1.

### FIELD

The present disclosure relates to a method of manufacturing an off-road vehicle and the off-road vehicle.

### BACKGROUND

U.S. Pat. No. 6,896,319 discloses a vehicle including a chassis and first to fourth modules disposed on the chassis. The first module defines a first passenger compartment. The second module defines a second passenger compartment. The third module defines an engine compartment. The fourth module defines a storage compartment.

### SUMMARY

It is important for an off-road vehicle to improve production efficiency in view of reducing production costs.

In view of this point, the present disclosure has been achieved to improve production efficiency of an off-road vehicle.

### BRIEF DESCRIPTION OF THE DRAWINGS

FIG. 1 is a side view of a utility vehicle.

FIG. 2 is a conceptual diagram of the utility vehicle including modularized parts.

FIG. 3 is a perspective view of the utility vehicle, partially disassembled, as viewed diagonally from the front left.

FIG. 4 is a perspective view of a vehicle frame as viewed diagonally from the front left.

FIG. 5 is a perspective view of the vehicle frame, seats, and a ROPS as viewed diagonally from the rear left.

FIG. 6 is a perspective view corresponding to FIG. 4, illustrating a vehicle front part with a dotted pattern.

FIG. 7 is a perspective view corresponding to FIG. 4, illustrating a vehicle rear part with a dotted pattern.

FIG. 8 is a perspective view of the utility vehicle, partially disassembled, as viewed diagonally from the rear left.

FIG. 9 is a perspective view corresponding to FIG. 4, illustrating seat row modules with a dotted pattern.

FIG. 10 is a perspective view of the utility vehicle, partially disassembled, as viewed from the left.

### DESCRIPTION OF EMBODIMENTS

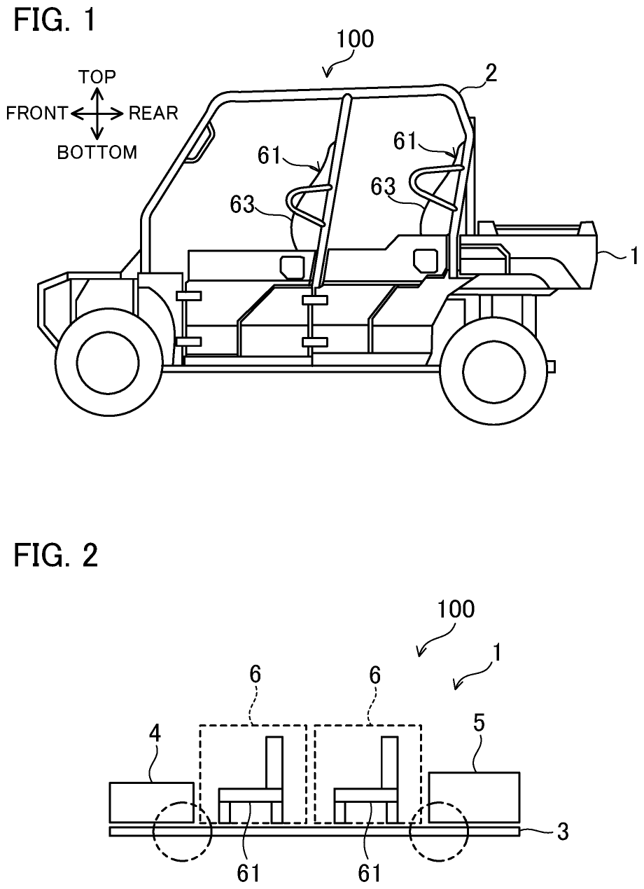

Exemplary embodiments will be described in detail below with reference to the drawings. FIG. 1 is a side view of a utility vehicle 100.

The utility vehicle 100 is a four-wheeled vehicle capable of traveling off-road. The utility vehicle 100 is an example of an off-road vehicle. The utility vehicle 100 may be hereinafter simply referred to as a “vehicle 100.”

In the present disclosure, components of the utility vehicle 100 will be described by way of directions relative to the utility vehicle 100. Specifically, the “front” is a front side of the vehicle 100 in a longitudinal direction (i.e., a front-rear direction), and the “rear” is a rear side of the vehicle 100 in the longitudinal direction. The “left” is a left side of the vehicle 100 facing the front, and the “right” is a right side of the vehicle 100 facing the front. A left-right direction of the vehicle may also be referred to as a “lateral direction” of the vehicle (i.e., a vehicle width direction). In the present disclosure, a member extending in a certain direction includes not only a member extending strictly parallel to the certain direction, but also a member extending along the certain direction.

The vehicle 100 includes a vehicle body 1. The vehicle 100 may further include a roll-over protective structure (ROPS) 2 detachably attached to the vehicle body 1. The ROPS 2 protects passengers when the vehicle 100 falls down.

At least part of the vehicle 100 is made of a combination of modules (units) each including predetermined parts assembled together. In this example, at least part of the vehicle body 1 of the vehicle 100 is modularized.

FIG. 2 is a conceptual diagram of the vehicle 100 including modularized parts. The vehicle 100 includes a ladder frame 3, a vehicle front part 4 mounted on top of the ladder frame 3, a vehicle rear part 5 mounted on top of the ladder frame 3, and one or a plurality of seat row modules 6 mounted on top of the ladder frame 3 between the vehicle front part 4 and the vehicle rear part 5. The vehicle front part 4, the vehicle rear part 5, and the seat row modules 6 are attached to the ladder frame 3. Specifically, the vehicle body 1 includes the ladder frame 3, the vehicle front part 4, the vehicle rear part 5, and the one or plurality of seat row modules 6 including modularized parts. The vehicle body 1 may include other parts than the vehicle front part 4, the vehicle rear part 5, and the seat row modules 6, such as pillars, frames, and cross members.

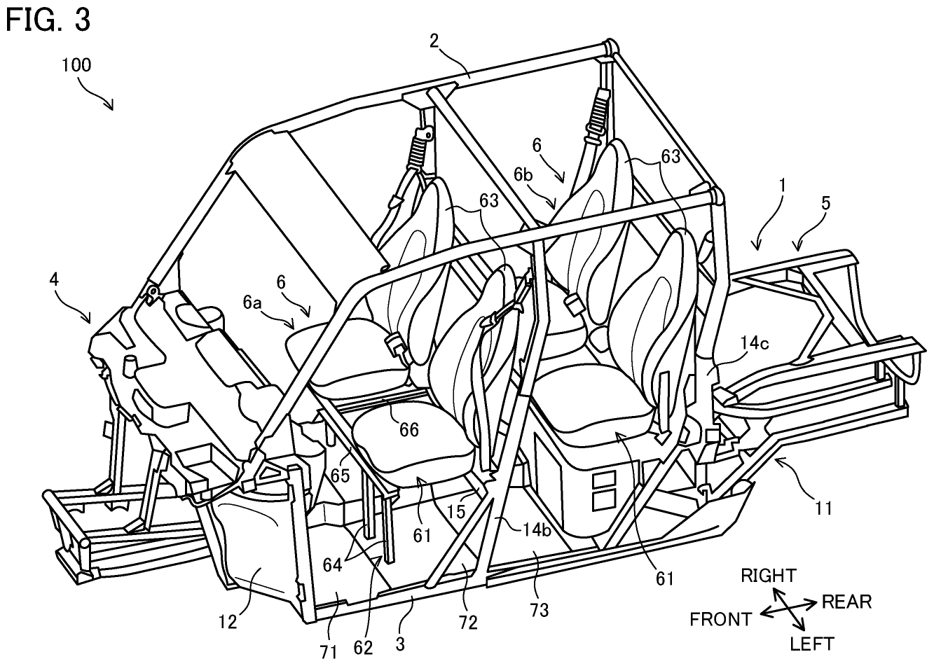

FIG. 3 is a perspective view of the vehicle 100 as viewed diagonally from the front left. An outer panel and other parts are not shown in FIG. 3. The vehicle 100 (specifically, the one or plurality of seat row modules 6) has one or a plurality of seat rows 61. In this example, the vehicle 100 has two seat rows 61. That is, the vehicle 100 is an off-road vehicle with two seat rows. In this example, each of the seat rows 61 has two seats 63 arranged side by side in the lateral direction of the vehicle.

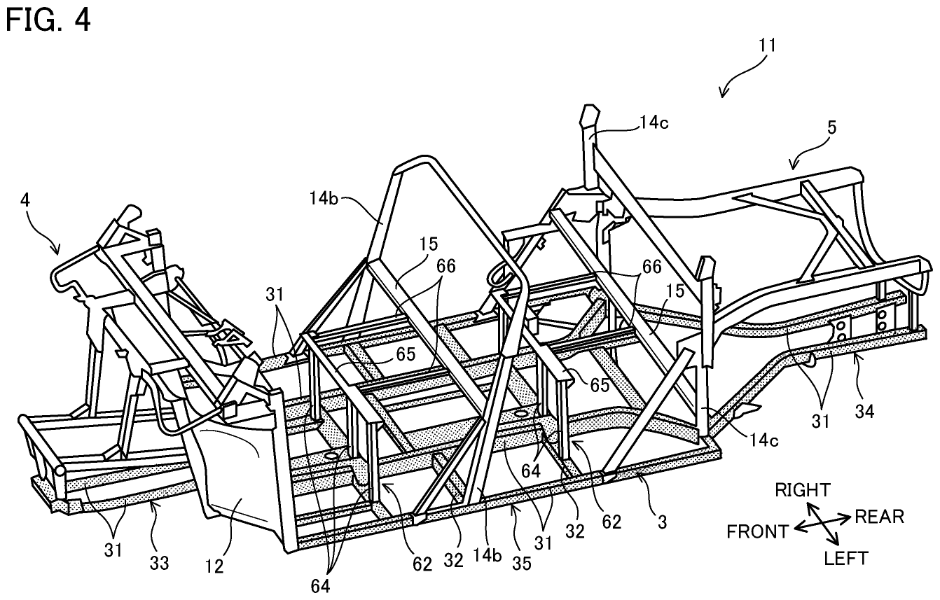

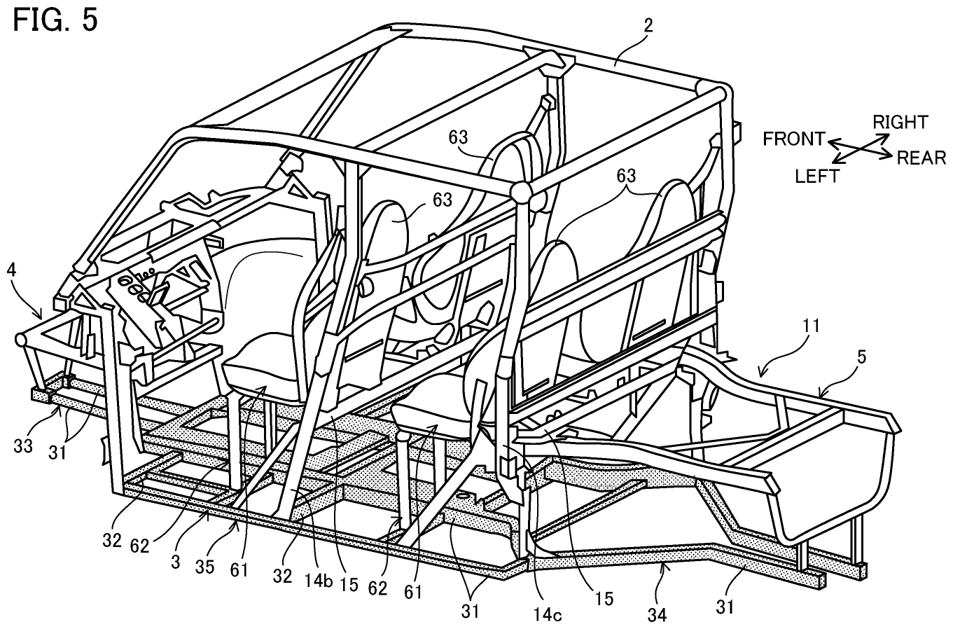

FIG. 4 is a perspective view of a vehicle frame 11 as viewed diagonally from the front left. FIG. 5 is a perspective view of the vehicle frame 11, the seats 63, and the ROPS 2 as viewed diagonally from the rear left. In FIGS. 4 and 5, the ladder frame 3 is illustrated with a dotted pattern for convenience of explanation. The vehicle body 1 (see FIG. 1) has the vehicle frame 11 including the ladder frame 3 and other parts. The vehicle frame 11 is a frame group that serves as a basic skeleton of the vehicle body 1. Frames constituting the vehicle frame 11 are, for example, metal pipes.

The ladder frame 3 is a ladder-shaped frame. The ladder frame 3 is part of the vehicle frame 11. The ladder frame 3 is a frame group arranged at the bottom of the vehicle frame 11. Specifically, the ladder frame 3 includes first frames 31 extending in the longitudinal direction and second frames 32 extending in the lateral direction. The first frames 31 are arranged side by side in the lateral direction. The second frames 32 are arranged side by side in the longitudinal direction. The first frames 31 intersect with and coupled to the second frames 32.

The ladder frame 3 has a predetermined length in the longitudinal direction. Specifically, the ladder frame 3 has a length in the longitudinal direction corresponding to the number of the seat rows 61 included in the vehicle body 1. That is, the ladder frame 3 has a length in the longitudinal direction that allows the vehicle front part 4, the vehicle rear part 5, and the one or plurality of seat row modules 6 to be mounted on top of the ladder frame 3. More specifically, the ladder frame 3 includes a front part 33 on which the vehicle front part 4 is mounted, a rear part 34 on which the vehicle rear part 5 is mounted, and an intermediate part 35 on which the one or plurality of seat row modules 6 are mounted. The front part 33, the intermediate part 35, and the rear part 34 are arranged in this order from the front to the rear. The intermediate part 35 has a length in the longitudinal direction corresponding to the number of seat rows. Specifically, when a vehicle 100 with a single seat row and a vehicle 100 with two seat rows are compared, the intermediate parts 35 of the ladder frames 3 have different lengths in the longitudinal direction.

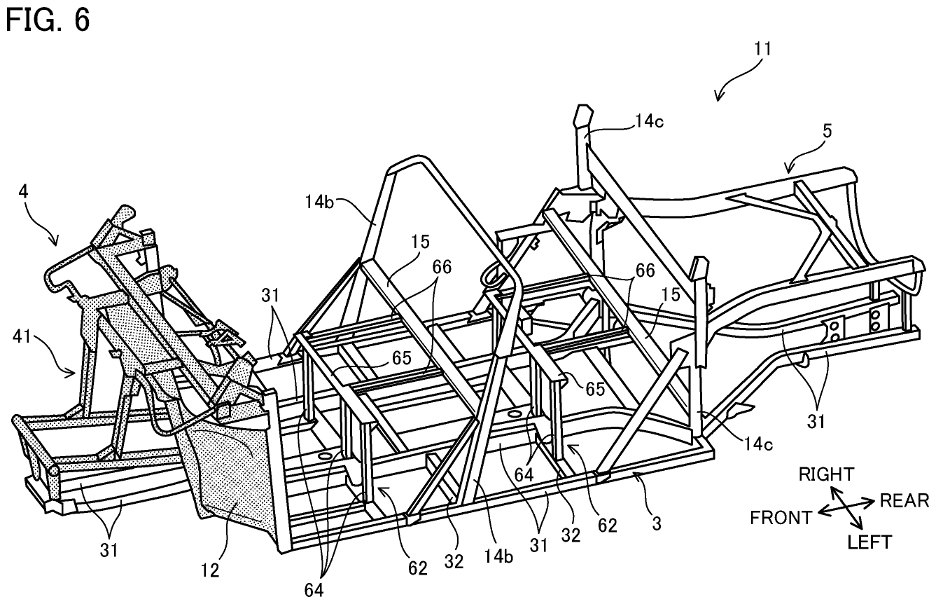

FIG. 6 is a perspective view corresponding to FIG. 4, illustrating the vehicle front part 4 with a dotted pattern. The vehicle front part 4 is a part of the vehicle body 1 (see FIG. 1) located forward of a compartment (i.e., a cabin). The vehicle front part 4 includes at least a front panel 12 that defines a front end of the compartment. The front panel 12 is, for example, a metal panel. The vehicle front part 4 is attached to the front part 33 of the ladder frame 3. The vehicle front part 4 may include a front room for housing, for example, a radiator or any other parts. The vehicle front part 4 may further include other parts such as a front frame group 41 that serves as a skeleton of the vehicle front part 4, a hood, and an instrument panel.

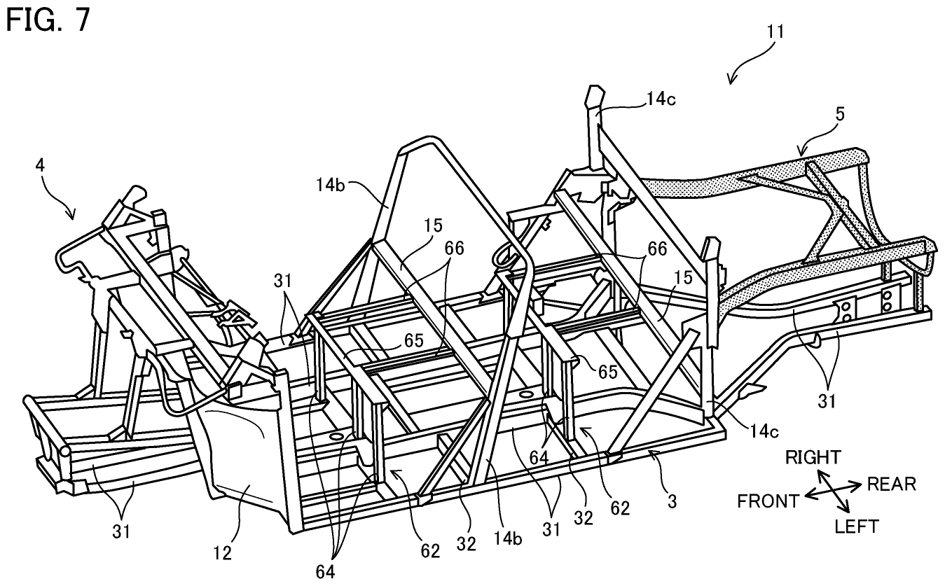

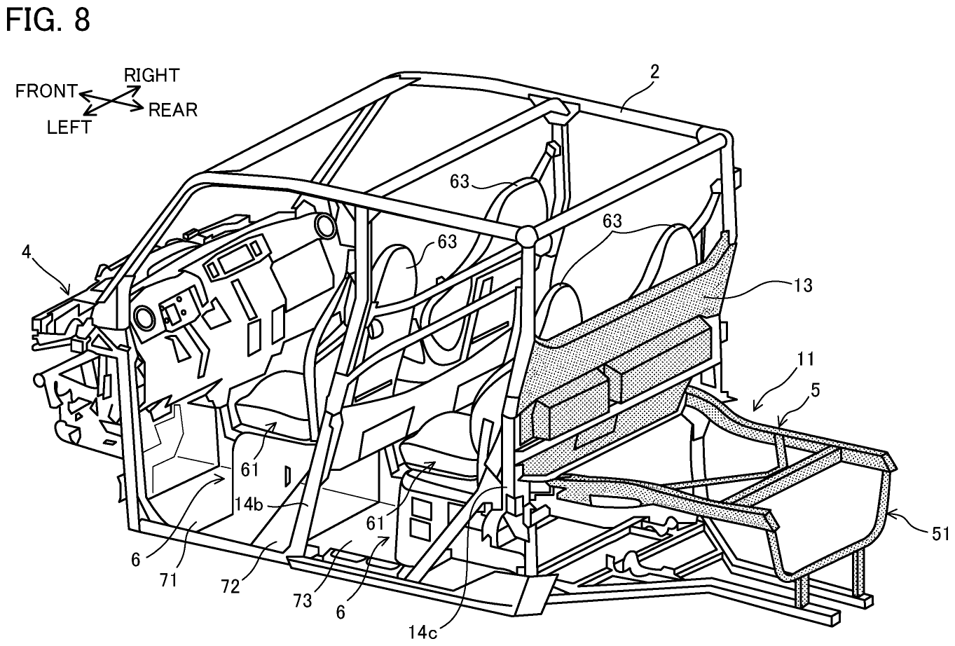

FIG. 7 is a perspective view corresponding to FIG. 4, illustrating the vehicle rear part 5 with a dotted pattern. FIG. 8 is a perspective view of the vehicle 100, partially disassembled, as viewed diagonally from the rear left. In FIG. 8, the vehicle rear part 5 is illustrated with a dotted pattern for convenience of explanation. An outer panel and other parts are not shown in FIG. 8 for convenience of explanation. The vehicle rear part 5 is a part of the vehicle body 1 (see FIG. 1) located rearward of the compartment. As shown in FIG. 8, the vehicle rear part 5 includes at least a rear panel 13 that defines a rear end of the compartment. The rear panel 13 is made of, for example, metal or resin. The rear panel 13 is arranged behind the rearmost seat row 61. The vehicle rear part 5 is attached to the rear part 34 of the ladder frame 3. The vehicle rear part 5 may include a platform (i.e., a cargo bed). The vehicle rear part 5 may further include a rear frame group 51 that serves as a skeleton of the vehicle rear part 5.

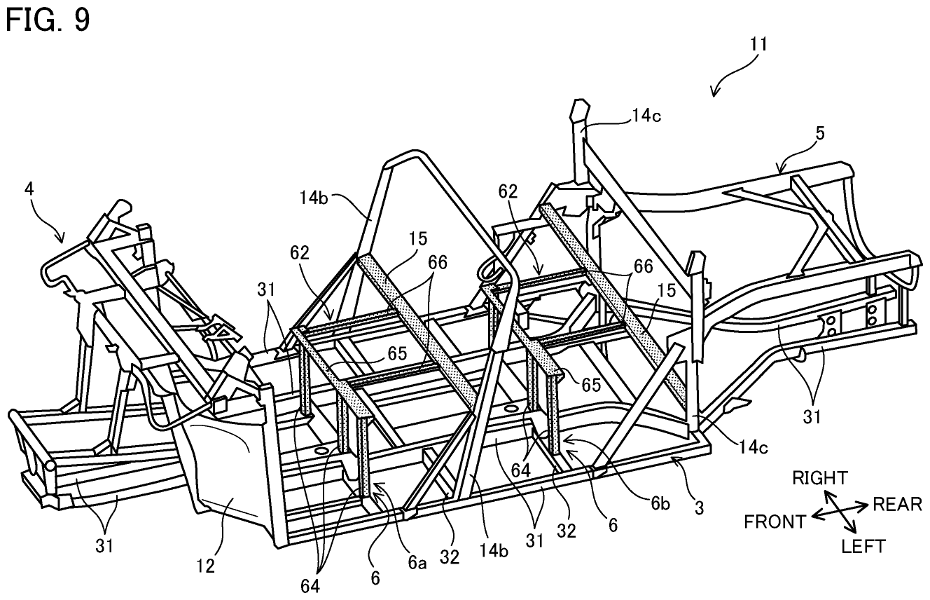

FIG. 9 is a perspective view corresponding to FIG. 4, illustrating the seat row modules 6 with a dotted pattern. Each of the seat row modules 6 corresponds to an associated one of the seat rows 61 arranged in the compartment. The number of the seat row modules 6 corresponds to the number of the seat rows 61 (i.e., the number of the one or plurality of seat rows) included in the vehicle body 1. The seat row modules 6 are arranged side by side in the longitudinal direction. The vehicle 100 has two seat row modules 6. That is, the seat row modules 6 include a first seat row module 6a and a second seat row module 6b arranged behind the first seat row module 6a. The first seat row module 6a corresponds to the front seat row 61 (see FIG. 3). The second seat row module 6b corresponds to the rear seat row 61 (see FIG. 3). In the following description, the first and second seat row modules 6a and 6b will be collectively referred to as a seat row module 6 when no distinction between them is required.

The seat row module 6 includes a seat frame 62 supporting the seat row 61. As shown in FIG. 3, the seat row 61 includes seats 63 arranged side by side in the lateral direction of the vehicle. Thus, the seat frame 62 supports the seats 63 arranged side by side in the lateral direction of the vehicle.

As shown in FIG. 9, the seat frame 62 includes vertical frames 64 extending in the vertical direction (i.e., an upper-lower direction), a lateral frame 65 extending in the lateral direction, and longitudinal frames 66 extending in the longitudinal direction. Specifically, the seat frame 62 includes three vertical frames 64, a single lateral frame 65, and two longitudinal frames 66. The vertical frames 64, the lateral frame 65, and the longitudinal frames 66 are located below the seat row 61 (see FIG. 3). The vertical frames 64 are arranged side by side in the lateral direction. Lower ends of the vertical frames 64 are coupled to the ladder frame 3. Upper ends of the vertical frames 64 are coupled to the lateral frame 65. The longitudinal frames 66 are arranged side by side in the lateral direction. A front end of one of the longitudinal frames 66 is coupled to a joint between the middle one of the three vertical frames 64 arranged side by side in the lateral direction and the lateral frame 65. A front end of the other longitudinal frame 66 is coupled to a joint between the right one of the three vertical frames 64 arranged side by side in the lateral direction and the lateral frame 65. Rear ends of the longitudinal frames 66 are coupled to a pillar cross member 15 which will be described later. As shown in FIG. 3, the seats 63 of the seat row 61 are attached to the lateral frame 65 and the longitudinal frames 66. Thus, the seat row 61 is supported by the seat frame 62.

As shown in FIGS. 3 and 9, the seat row module 6 may further include a pillar cross member 15 which couples a pair of pillars 14 arranged side by side in the lateral direction and to which the seat frame 62 (specifically, the longitudinal frames 66) is attached, and the seat row 61. The pillars 14 are arranged at ends of the vehicle body 1 in the lateral direction and extends roughly in the vertical direction. The pillars 14 include at least B pillars 14b and C pillars 14c arranged behind the B pillars 14b. In terms of position in the longitudinal direction, the B pillars 14b are located behind the front seat row 61, and the C pillars 14c are located behind the rear seat row 61. The B pillars 14b and the C pillars 14c will be collectively referred to as pillars 14 when no distinction between them is required.

The pillar cross member 15 of the first seat row module 6a extends in the lateral direction behind the front seats 63 and is coupled to the pair of B pillars 14b. The pillar cross member 15 of the second seat row module 6 extends in the lateral direction behind the rear seats 63 and is coupled to the pair of C pillars 14c. When distinction is required between the pillar cross member 15 of the first seat row module 6a and the pillar cross member 15 of the second seat row module 6b, the former will be referred to as a first pillar cross member 15a, and the latter will be referred to as a second pillar cross member 15b. When no distinction is required between the pillar cross members 15a and 15b, they will be collectively referred to as the pillar cross members 15. The pillar cross members 15 are part of the vehicle frame 11.

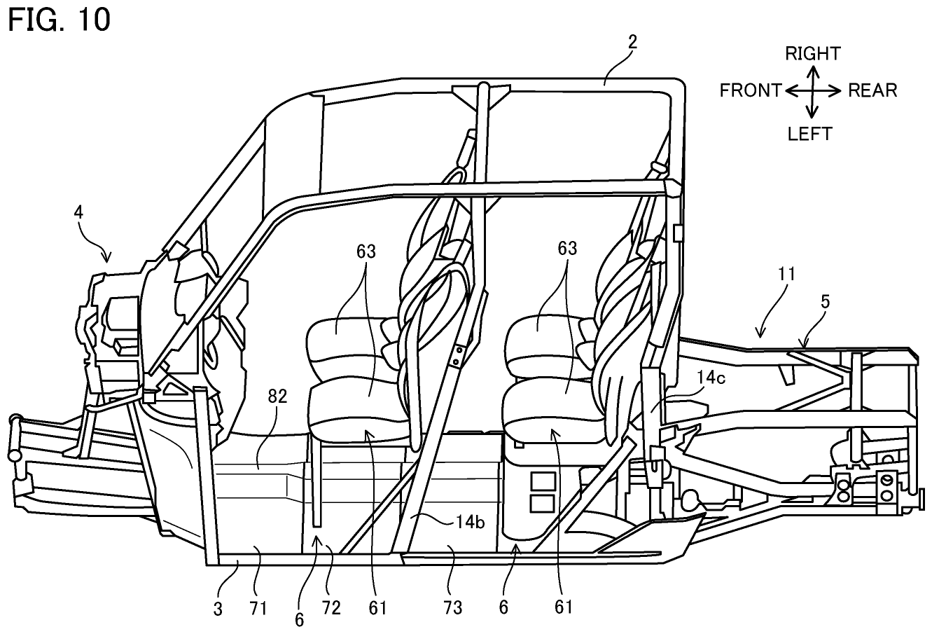

FIG. 10 is a perspective view of the vehicle 100 as viewed from the left. The vehicle 100 may further include a first floor panel 71, a second floor panel 72, and a third floor panel 73. The first floor panel 71 is arranged below the feet of the passengers on the front seats 63. The second floor panel 72 is arranged just below the front seats 63. The third floor panel 73 is arranged below the feet of the passengers on the rear seats 63.

The first, second, and third floor panels 71, 72, and 73 are arranged in this order from the front to the rear. A rear end of the first floor panel 71 is coupled to a front end of the second floor panel 72. A rear end of the second floor panel 72 is coupled to a front end of the third floor panel 73. Each of the first, second, and third floor panels 71, 72, and 73 extends roughly in the lateral direction to cover at least part of a center tunnel 82 in the longitudinal direction. Each of the first, second, and third floor panels 71, 72, and 73 is made of, for example, resin. Each of the first, second, and third floor panels 71, 72, and 73 extends horizontally in the longitudinal direction. That is, each of the first, second, and third floor panels 71, 72, and 73 extends linearly on a section orthogonal to the lateral direction.

The seat row modules 6 attached to the ladder frame 3 are common. When some members are “common,” the members have a common fundamental component. In this example, the first and second seat row modules 6a and 6b are common. That is, the first and second seat row modules 6a and 6b have common fundamental components. That is, the first and second seat row modules 6a and 6b have the common seat frames 62, i.e., the three vertical frames 64, the lateral frame 65, and the two longitudinal frames 66. In this example, the first and second seat row modules 6a and 6b have the common pillar cross members 15 and the common seat rows 61. The common fundamental components, i.e., the seat frame 62, the pillar cross members 15, and the seat rows 61, have the same or almost the same shape.

Note that the common fundamental components may have minute differences. For example, the first pillar cross member 15a and the second pillar cross member 15b are coupled to the different pillars 14. The ends of the first pillar cross member 15a are shaped to be suitably attached to the B pillars 14b. The ends of the second pillar cross member 15b are shaped to be suitably attached to the C pillars 14c. The B pillars 14b and the C pillars 14c may have different inclinations or cross-sectional shapes. Thus, the ends of the first pillar cross member 15a and the ends of the second pillar cross member 15b may have the shapes slightly different from each other. Further, the vehicles 100 with different numbers of seat rows may have the common vehicle front parts 4. In other words, the vehicle front parts 4 among the vehicles 100 with different numbers of seat rows may be common. This can reduce the types of parts used for the manufacture of the vehicles 100 with different numbers of seat rows. The vehicles 100 with different numbers of seat rows may have the common vehicle rear parts 5. In other words, the vehicle rear parts 5 among the vehicles 100 with different numbers of seat rows may be common. This can reduce the types of parts used for the manufacture of the vehicles 100 with different numbers of seat rows.

A method for manufacturing the vehicle 100 will be described below. The method of manufacturing the vehicle 100 includes preparing the ladder frame 3, attaching the vehicle front part 4 to the ladder frame 3, attaching the vehicle rear part 5 to the ladder frame 3, and attaching the one or plurality of seat row modules 6 to the ladder frame 3. The number of the one or plurality of seat row modules 6 corresponds to the number of the seat rows 61 included in the vehicle body 1. Since the vehicle 100 of this example is an off-road vehicle with two seat rows as described above, the number of the one or plurality of seat row modules 6 is two. That is, the method of manufacturing the vehicle 100 includes attaching the first and second seat row modules 6a and 6b to the ladder frame 3. For the manufacture of the vehicle 100 with a single seat row, a single seat row module 6 is attached to the ladder frame 3.

Specifically, the preparing of the ladder frame 3 includes preparing the ladder frame 3 having a length in the longitudinal direction corresponding to the number of the seat rows 61 included in the vehicle body 1 as shown in FIG. 5.

In attaching the vehicle front part 4 to the ladder frame 3, the vehicle front part 4 is placed in position on the front part 33 of the ladder frame 3. Then, the vehicle front part 4 is attached to the front part 33 of the ladder frame 3 by, for example, welding.

In attaching the vehicle rear part 5 to the ladder frame 3, the vehicle rear part 5 is placed in position on the rear part 34 of the ladder frame 3. Then, the vehicle rear part 5 is attached to the rear part 34 of the ladder frame 3 by, for example, welding.

In attaching the one or plurality of seat row modules 6 to the ladder frame 3, i.e., in attaching the first and second seat row modules 6a and 6b to the ladder frame 3, for example, the first pillar cross member 15a of the first seat row module 6a is attached to the pair of B pillars 14b by, for example, welding. The seat frame 62 is attached to the ladder frame 3 and the first pillar cross member 15a by, for example, welding. The seat row 61 is attached onto the seat frame 62 with fasteners such as bolts. Thus, the first seat row module 6a is attached to the ladder frame 3. There is no limit on the order of attaching the first pillar cross member 15a, the seat frame 62, and the seat row 61. Each of the first pillar cross member 15a, the seat frame 62, and the seat row 61 may be entirely or partially assembled in advance, and the assembly may be attached to the ladder frame 3.

The second seat row module 6b is attached to the ladder frame 3 behind the first seat row module 6a. The second pillar cross member 15b is attached to the C pillars 14c. The second seat row module 6b is attached basically in the same manner as the first seat row module 6a except for these points. In this example, the first, second, and third floor panels 71, 72, and 73 are attached to the ladder frame 3 with fasteners such as rivets.

The seat row modules 6 attached to the ladder frame 3 are common. In this example, the second seat row module 6b is common with the first seat row module 6a as described above.

By this method of manufacturing the vehicle 100, the one or plurality of seat row modules 6 are attached to the ladder frame 3. The number of the one or plurality of seat row modules 6 corresponds to the number of the seat row 61. That is, by this manufacturing method, different types of vehicles 100 can be manufactured by increasing or reducing the number of the seat row modules 6 including modularized parts according to the number of the seat rows 61. This can reduce the types of parts used for the manufacture of the vehicles 100 with different numbers of seat rows. When the number of the seat row modules 6 is changed and the ladder frame 3 of different lengths are prepared, the vehicles 100 with different numbers of seat rows can be manufactured without making drastic design changes. This can improve the production efficiency of the vehicle 100.

In the method of manufacturing the vehicle 100, the ladder frame 3 having a length in the longitudinal direction corresponding to the number of the seat rows 61 is prepared. This method can adapt to the change in the number of seat rows by merely changing the length of the ladder frame 3 in the longitudinal direction, i.e., the length in the longitudinal direction of the intermediate part 35 of the ladder frame 3 on which the seat row modules 6 are mounted. Although the number of seat rows changes, no change is required for the front part 33 and rear part 34 of the ladder frame 3 on which the vehicle front part 4 and the vehicle rear part 5 are mounted. This can reduce the changes required for the ladder frame 3 according to the change in the number of seat rows.

In this example, the seat row module 6 includes the seat frame 62, the pillar cross member 15, and the seat row 61. That is, the first and second seat row modules 6a and 6b have the common seat frames 62, the common pillar cross members 15, and the common seat rows 61. This can reduce the types of each of the seat frame 62, the pillar cross member 15, and the seat row 61.

### OTHER EMBODIMENTS

The exemplary embodiment has been described above as an example of the technique disclosed in the present application. However, the present disclosure is not limited to this exemplary embodiment, but is also applicable to other embodiments which are altered or substituted, to which other features are added, or from which some features are omitted, as needed. The components described in the embodiment may be combined to create a new embodiment. The components illustrated on the accompanying drawings and described in the detailed description include not only essential components that need to be used to overcome the problem, but also other unessential components that do not have to be used to overcome the problem. Therefore, such unessential components should not be taken for essential ones, simply because such unessential components are illustrated in the drawings or mentioned in the detailed description.

For example, the off-road vehicle is not limited to the utility vehicle 100. The off-road vehicle may be, for example, an all-terrain vehicle (ATV) or a tractor. The off-road vehicle is not limited to the four-wheeled vehicle, and may be, for example, a three-wheeled vehicle. The ROPS 2 is not an essential component.

The vehicle front part 4 is not limited to the front room for housing the radiator or any other parts. The vehicle rear part 5 is not limited to the platform. It is only required for the seat row module 6 to include at least the seat frame 62. There is no limit on the number of the seat row modules 6. The vehicle may have one seat row module 6 or three or more seat row modules 6. There is no limit on the number of the seats 63 arranged side by side in the lateral direction. Three or more seats 63 may be arranged side by side in the lateral direction. Although it is described in the embodiment that the seat frame 62 includes the vertical frames 64, the lateral frame 65, and the longitudinal frames 66, the seat frame 62 is not limited to include these frames and may have any structure as long as it can support the seat row 61.

The seat row module 6 may include a floor panel. Specifically, the first seat row module 6a may include the first floor panel 71, and the second seat row module 6b may include the third floor panel 73. The first floor panel 71 may be common with the third floor panel 73. In this example, the first floor panel 71 extends horizontally in the longitudinal direction, and thus, the first floor panel 71 can be coupled with no clearance to a member adjacent to the first floor panel 71 in the longitudinal direction (e.g., the second floor panel 72). Likewise, in this example, the third floor panel 73 extends horizontally in the longitudinal direction, and thus, the third floor panel 73 can be coupled with no clearance to a member adjacent to the third floor panel 73 in the longitudinal direction (e.g., the second floor panel 72).

In preparing the ladder frame 3, it is not necessary to prepare the ladder frame 3 having a length in the longitudinal direction corresponding to the number of the seat rows 61. In attaching the vehicle front part 4 to the ladder frame 3, the vehicle front part 4 as an assembly of components may be attached to the front part of the ladder frame 3, or the components of the vehicle front part 4 may be attached one by one to the front part of the ladder frame 3. Likewise, in attaching the vehicle rear part 5 to the ladder frame 3, the vehicle rear part 5 as an assembly of components may be attached to the rear part of the ladder frame 3, or the components of the vehicle rear part 5 may be attached one by one to the rear part of the ladder frame 3.

In the manufacture of the vehicle 100, the vehicle front part 4, the vehicle rear part 5, and the one or plurality of seat row modules 6 may be attached to the ladder frame 3 in any order.

### Aspects

The embodiment described above is a specific example of the following aspects.

(First aspect) A method of manufacturing a utility vehicle 100 (off-road vehicle) includes: preparing a ladder frame 3; attaching a vehicle front part 4 that includes a front panel 12 defining a front end of a compartment and is mounted on top of the ladder frame 3 to the ladder frame 3; attaching a vehicle rear part 5 that includes a rear panel 13 defining a rear end of the compartment and is mounted on top of the ladder frame 3 to the ladder frame 3; and attaching one or a plurality of seat row modules 6, each of which includes a seat frame 62 supporting a seat row 61 having seats 63 arranged side by side in a lateral direction of the vehicle and is mounted on top of the ladder frame 3, to the ladder frame 3 between the vehicle front part 4 and the vehicle rear part 5. The number of the seat row modules 6 corresponds to the number of the seat rows 61 included in a vehicle body 1.

In this aspect, the one or plurality of seat row modules 6 are attached to the ladder frame 3, and the number of the one or plurality of seat row modules 6 corresponds to the number of the seat rows 61. That is, different types of utility vehicles 100 can be manufactured by increasing or reducing the number of the seat row modules 6 including modularized parts according to the number of the seat rows 61. This can reduce the types of parts used for the manufacture of the utility vehicles 100 with different numbers of seat rows. When the number of the seat row modules 6 is changed, the utility vehicles 100 with different numbers of seat rows can be manufactured without making drastic design changes. This can improve the production efficiency of the utility vehicle 100.

(Second aspect) In the method of manufacturing the utility vehicle 100 of the first aspect, the plurality of seat row modules 6 attached to the ladder frame 3 are common.

In this aspect, the types of parts used can be reduced because the seat row modules 6 are common. This can further improve the production efficiency of the utility vehicle 100 in the manufacture of the utility vehicles 100 with different numbers of seat rows 61.

(Third aspect) In the method of manufacturing the utility vehicle 100 of the first or second aspect, the one or plurality of seat row modules 6 further include a pillar cross member 15 which couples a pair of pillars 14 arranged side by side in the lateral direction of the vehicle and to which the seat frame 62 is attached, and the seat row 61.

This can reduce the types of each of the pillar cross member 15 and the seat row 61 in the manufacture of the utility vehicles 100 with different numbers of seat rows 61.

(Fourth aspect) In the method of manufacturing the utility vehicle 100 of any one of the first to third aspects, the preparing of the ladder frame 3 includes preparing the ladder frame 3 having a length in the longitudinal direction corresponding to the number of seat rows 61 included in the vehicle body 1.

In this aspect, the method can adapt to the change in the number of seat rows by merely changing the length of the ladder frame 3 in the longitudinal direction. This can reduce the changes required for the ladder frame 3 according to the change in the number of seat rows.

(Sixth aspect) A utility vehicle 100 includes: a ladder frame 3; a vehicle front part 4 that includes a front panel 12 defining a front end of a compartment and is mounted on top of the ladder frame 3; a vehicle rear part 5 that includes a rear panel 13 defining a rear end of the compartment and is mounted on top of the ladder frame 3; and a plurality of seat row modules 6, each of which includes a seat frame 62 supporting a seat row 61 having two or more seats 63 arranged side by side in a lateral direction of the vehicle and is mounted on top of the ladder frame 3 between the vehicle front part 4 and the vehicle rear part 5. The plurality of seat row modules 6 include a first seat row module 6a and a second seat row module 6b arranged behind the first seat row module 6a and includes a seat frame 62 common with the seat frame 62 of the first seat row module 6a.

In this aspect, the seat frame 62 of the first seat row module 6a is common with the seat frame 62 of the second seat row module 6b. Thus, the utility vehicles 100 with different numbers of seat rows can be manufactured without drastically changing the design of the seat frame 62. That is, the utility vehicles 100 with various numbers of seat rows can be manufactured by changing the number of the seat row modules 6. Since the common seat frames 62 are used, the types of parts used for the manufacture of the utility vehicles 100 with different numbers of seat rows can be reduced. This can improve the production efficiency of the utility vehicle 100.

What is claimed is:

1. A method of manufacturing an off-road vehicle, the method comprising:
preparing a ladder frame;
attaching a vehicle front part that includes a front panel defining a front end of a compartment and is mounted on top of the ladder frame to the ladder frame;
attaching a vehicle rear part that includes a rear panel defining a rear end of the compartment and is mounted on top of the ladder frame to the ladder frame; and
attaching one or a plurality of seat row modules, each of which includes a seat frame supporting a seat row having seats arranged side by side in a lateral direction of the vehicle and is mounted on top of the ladder frame between the vehicle front part and the vehicle rear part, to the ladder frame, wherein
the number of the one or plurality of seat row modules corresponds to the number of the seat rows included in a vehicle body.

2. The method of manufacturing the off-road vehicle of claim 1, wherein
the plurality of seat row modules attached to the ladder frame are common.

3. The method of manufacturing the off-road vehicle of claim 1, wherein
the one or plurality of seat row modules further include a pillar cross member which couples a pair of pillars arranged side by side in the lateral direction of the vehicle and to which the seat frame is attached, and the seat row.

4. The method of manufacturing the off-road vehicle of claim 1, wherein
the preparing of the ladder frame includes preparing the ladder frame having a length in a longitudinal direction corresponding to the number of the seat rows included in the vehicle body.

5. An off-road vehicle, comprising: a ladder frame;
a vehicle front part that includes a front panel defining a front end of a compartment and is mounted on top of the ladder frame;
a vehicle rear part that includes a rear panel defining a rear end of the compartment and is mounted on top of the ladder frame; and
seat row modules, each of which includes a seat frame supporting a seat row having seats arranged side by side in a lateral direction of the vehicle and is mounted on top of the ladder frame between the vehicle front part and the vehicle rear part, wherein
the seat row modules include a first seat row module and a second seat row module that is arranged behind the first seat row module and includes a seat frame common with the seat frame of the first seat row module.
